(19) United States
(12) Patent Application Publication
(10) Pub. No.: US 2001/0006772 A1
(43) Pub. Date: Jul. 5, 2001

(54) Method for conversion of blood type

(76) Inventors: Jack Goldstein, New York, NY (US); Leslie Lenny, Brooklyn, NY (US); Rosa Hurst, Staten Island, NY (US)

Correspondence Address: John R. Van Amsterdam, Wolf, Greenfield & Sacks, P.C., 600 Atlantic Avenue, Boston, MA, 02210, US

(21) Appl. No.: 09/735,400

(22) Filed: Dec. 12, 2000

Related U.S. Application Data
(63) Continuation of application No. 08/753,212, filed on Nov. 21, 1996, now abandoned.

(51) Int. Cl. A01N 1/02

(52) U.S. Cl. 435/2; 435/440

(57) ABSTRACT

The present invention relates to an improved method for enzymatically removing blood type-specific antigens from erythrocytes, comprising titrating the pH of the erythrocytes first to a pH suitable for enzyme activity and then, once the desired extent of antigen removal has been achieved, to a pH appropriate for storage and/or transfusion. The buffers used for titration have pH values significantly above or below the target pHs for erythrocyte conversion or storage/transfusion. The invention is based, at least in part, on the discovery that the structural integrity of the erythrocytes is not substantially disrupted by titration. The present invention further relates to methods wherein the addition of polyethylene glycol improves the efficiency of enzymatic removal of erythrocyte antigens.

This invention was made, at least in part, with Government support under Grant No. N00014-93-1-0364 from the Office of Naval Research and Development Command, such that the United States Government may have certain rights herein.

### 1. INTRODUCTION

The present invention relates to an enzymatic method for removing blood type-specific antigens from erythrocytes.

### 2. BACKGROUND OF THE INVENTION

Based on the presence or absence of defined antigens, human blood may be classified into four main types, or groups, designated O, A, B, and AB. There are three major recognized subtypes of blood type A, known as A₁, Aᵢₙₜ, and A₂.

The carbohydrate structures associated with A₁, A₂, B and O blood types are shown in FIGS. 1A-1D. While A₂ and B antigens consist of a single, external, antigenic component, the A₁ antigen comprises two antigenic components, the major component having an external residue (FIG. 1B) and the minor component having both an external as well as an internal residue (FIG. 1A), relative to the carbohydrate chain.

Individuals with type A red cells have, in their plasma, antibodies directed against type B red cells (anti-B antibodies). Conversely, individuals with type B red cells have anti-A antibodies in their plasma. Persons with type O blood have antibodies directed toward both A and B antigens.

The presence of such antibodies makes blood transfusions problematic. If the host to a transfusion carries antibodies against the donor blood, a severe and potentially life-threatening reaction can result. The only blood type that can be safely transfused into persons of all blood types is type O blood, which is often referred to as “universal donor” blood. However, the availability of type O blood is insufficient to meet transfusion needs, because less than half of the population has type O blood.

Moreover, as a result of the limited shelf-life of donated blood, a disparity between the supply of blood available and transfusion needs often leads to the destruction of large quantities of blood stored in blood banks internationally.

In order to satisfy the demand for safely transfusable blood, and to more efficiently utilize the donated blood supply, technology has been developed which converts erythrocytes which are type A, B, or AB to “universal donor” blood.

Conversion of blood type B to type O may be accomplished using α-galactosidase enzyme originating from green coffee bean (“B-zyme”), which cleaves at the α1,3 bond linking the terminal galactose to a carbohydrate structure identical to the H-antigen associated with type O blood (cleavage indicated by a dotted line in FIG. 1C). Blood converted by this method has been safely transfused into patients (see, for example, U.S. Pat. Nos. 4,330,619 and 4,427,777; Lenny et al., 1991, Blood 77:1383-1388; Goldstein, 1989, Transfusion Medicine Reviews III(3):206-212). The coffee bean α-galactosidase gene has been cloned, characterized, and expressed to produce recombinant enzyme for use in the conversion of type B erythrocytes (Zhu and Goldstein, 1994, Gene 140:227-231) and the cloned enzyme has also been used to produce erythrocytes for transfusion (Lenny et al., 1995, Transfusion 35:899-902).

Likewise, type Aᵢₙₜ-A₂ blood has been successfully deantigenized using α-N-acetylgalactosaminidase enzyme originating in chicken liver (“A-zyme”; U.S. Pat. No. 4,609,627; Goldstein et al., 1984, “Enzymatic Removal of Group A antigens” in Abstracts of the 18th Congress of the ISBT, Karger, Munich, p. 86; Goldstein, 1989, Transfusion Medicine Reviews III(3):206-212). The chicken liver α-N-acetylgalactosaminidase gene has been cloned, characterized, and expressed (Zhu and Goldstein, 1993, Gene 137:309-314).

Because the A₁ antigen comprises an internal as well as an external antigenic component, even after treatment with α-N-acetylgalactosaminidase, internal antigen remains. An endo-galactosidase is required to remove the internal antigen.

The endo-β-galactosidase from Flavobacterium keratolyticus may be used to remove this internal antigenic structure, as described in copending U.S. patent application Ser. No. 08/712,072, by Goldstein et al.

Previously known methods for enzymatic conversion of erythrocytes, however, suffer from a number of disadvantages. The methods set forth in U.S. Pat. Nos. 4,330,619 and 4,609,627 for example, include a number of equilibration steps both prior to and following enzymatic conversion. In particular, the pH of erythrocytes is first decreased to a pH of 5.6-5.8 (the pH range optimal for enzyme activity) by repeatedly suspending the cells in citrate-phosphate buffer at that pH. The erythrocytes are then enzymatically deantigenized, and finally another series of equilibrations using a buffer having a pH of 7.2-7.4 is used to remove the enzyme and restore the erythrocytes to physiological pH. These equilibration steps are not only time consuming but also are rather cumbersome, requiring substantial volumes of buffer and numerous centrifugation steps. Moreover, each time the system is opened to reintroduce buffer, an opportunity for a lapse in sterile conditions is created.

Multiple equilibration steps were implemented for several reasons. First, in order for erythrocytes to be deantigenized to the extent required to avoid a transfusion reaction, it has been necessary to perform enzyme treatment at a pH substantially lower than the physiologic pH of erythrocytes. Second, erythrocytes contain strong natural buffers which render them resistant to pH changes so that the required pH adjustments are difficult to effectuate. Finally, it was believed that gradual adjustment of pH is necessary in order to avoid structural distortion and hemolysis of erythrocytes.

If enzymatic methods are to be used, on a commercial scale, to deantigenize erythrocytes, it is desirable to employ a method which is not only time efficient, but which also uses relatively small buffer volumes and few washes in order to decrease the volume and cost of materials. Accordingly, the method of the invention was developed to address these issues.

### 3. SUMMARY OF THE INVENTION

The present invention relates to an improved method for enzymatically removing blood type-specific antigens from erythrocytes, comprising titrating the pH of the erythrocytes first to a pH suitable for enzyme activity and then, once the desired extent of antigen removal has been achieved, to a pH appropriate for storage and/or transfusion. The buffers used for titration have pH values significantly above or below the target pHs for erythrocyte conversion or storage/transfusion. The invention is based, at least in part, on the discovery that the structural and metabolic integrity of the erythrocytes is not substantially disrupted by titration.

### 4. DESCRIPTION OF THE FIGURES

FIG. 1A-D. Schematic diagrams of antigen structures associated with blood type: (A) the minor component of A₁ antigen, containing both internal as well as external antigenic residues; (B) the major component of A₁ antigen containing an external antigenic residue; (C) the antigen associated with type B blood and (D) the carbohydrate structure associated with universal donor type O blood.

FIG. 2A-B. Osmotic fragility studies of converted erythrocytes versus native erythrocytes converted without (A) or with (B) polyethylene glycol.

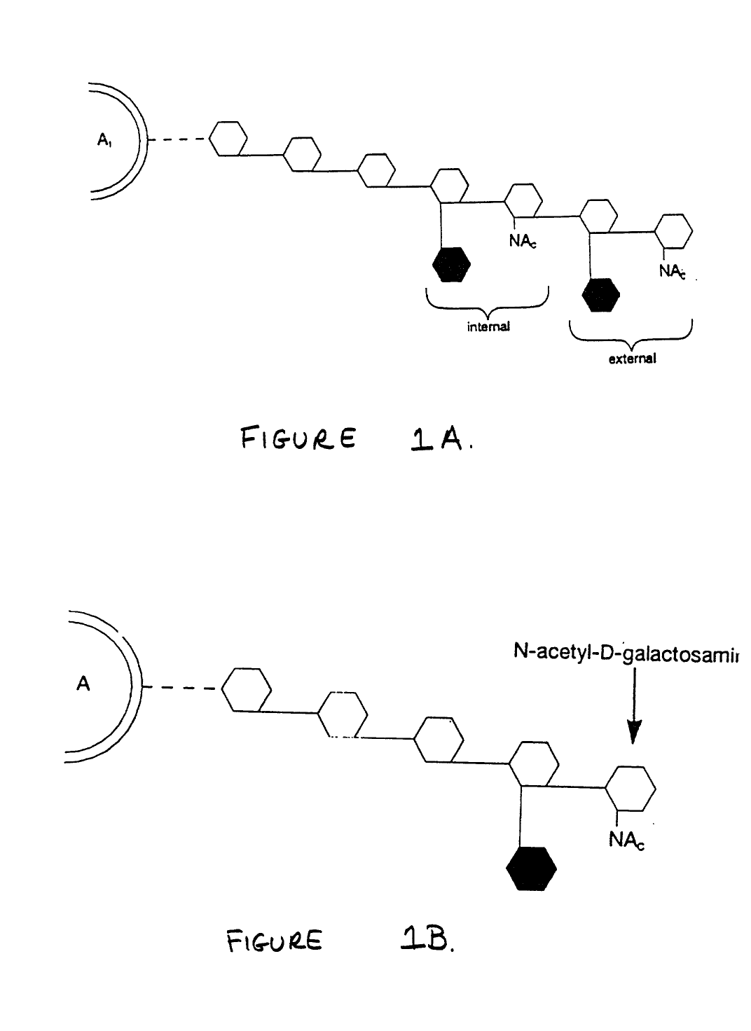

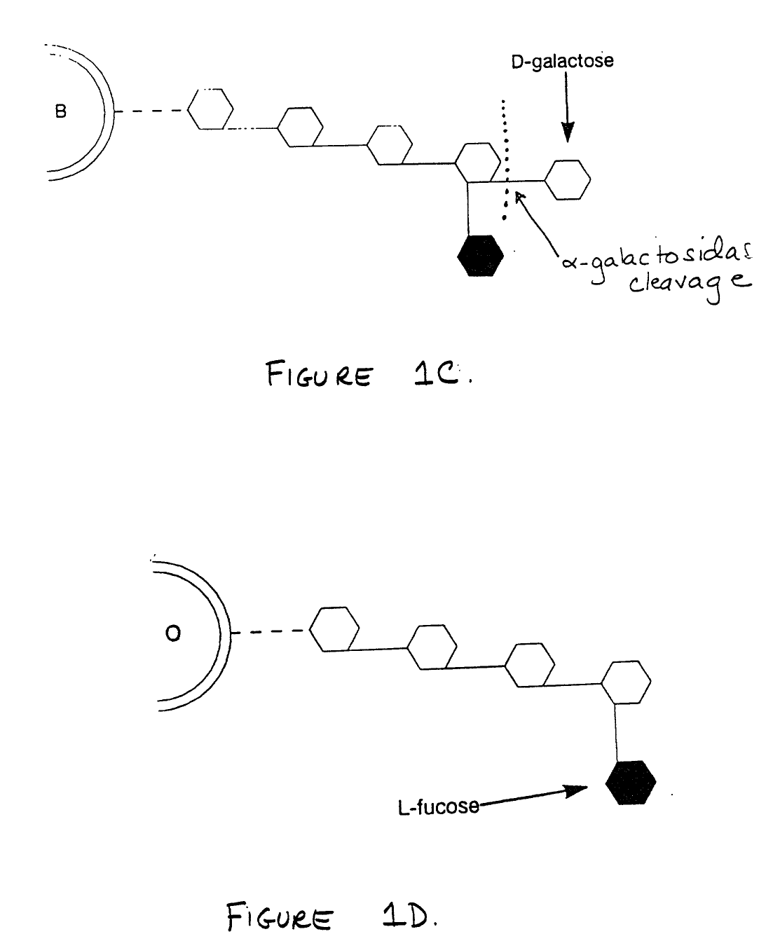

### 5. DETAILED DESCRIPTION OF THE INVENTION

For purposes of clarity of disclosure and not by way of limitation, the detailed description of the invention is divided into the following subsections, which sequentially describe the steps used to remove blood-type specific antigen from erythrocytes:

(i) preparation of erythrocytes;

(ii) titration of pH prior to enzyme treatment;

(iii) enzymatic removal of blood type-specific antigen; and

(iv) removal of enzyme and titration of pH.

### 5.1. PREPARATION OF ERYTHROCYTES

In order to use the methods of the invention to produce transfusable erythrocytes, erythrocytes are first obtained by collecting blood from a subject and then separating the erythrocytes from other blood components such as platelets and leukocytes, using standard techniques.

For example, but not by way of limitation, packed erythrocytes (i.e., packed red blood cells or packed RBC) may be prepared from collected whole blood by centrifugation at 1,250g-4,000 g for 4.8 minutes, conditions that remove platelets and most leukocytes.

Erythrocytes previously collected and prepared for storage may also be used according to the invention. Such preparations may, however, contain nutrients and/or preservatives that are desirably removed prior to enzyme treatment, although such removal is not required.

For practicing the invention, erythrocytes are preferably in suspension at a hematocrit value of at least about 80 percent, and more preferably between 85 and 95 percent. For example, but not by way of limitation, an erythrocyte suspension meeting such specifications may be produced by expressing supernatant from packed erythrocytes using a standard plasma expressor.

The resulting composition is referred to herein as a “native erythrocyte suspension”.

### 5.2. TITRATION OF pH PRIOR TO ENZYME TREATMENT

In order to enzymatically remove antigen from erythrocytes, it is necessary for the pH of the native erythrocyte suspension (prepared as set forth in the preceding section) to be in a range suitable for enzyme activity. In other words, the pH of the native erythrocyte suspension is adjusted to a level which permits the converting enzyme to function sufficiently to remove enough antigen so as to avoid a transfusion reaction. Such pH level, which is typically a range of pH values, is referred to herein as the “conversion pH”.

According to the present invention, the pH of a native erythrocyte suspension may be adjusted to the conversion pH by titration with a suitable buffer. The terms “titration” and “titrating”, as used herein, refer to the addition of a buffer solution (or its equivalent) which has a pH substantially different from the conversion pH or the pH of the native erythrocyte suspension (substantially different refers to a difference of at least one pH unit and preferably more than two pH units). Thus, in contrast to the prior art methods, which repeatedly suspend erythrocytes in solutions having the conversion pH, the method of the present invention alters the pH of a native erythrocyte suspension by the addition of a titrating buffer. The use of a titrating buffer allows the pH of the erythrocytes to be brought to the conversion pH in one or a few steps, and requires substantially lower volumes of buffer solutions relative to the prior art methods.

The buffer is preferably added to the native erythrocyte suspension while continuously mixing the suspension, in order to avoid exposure of erythrocytes to pH values which could damage the physical structure or physiology of the erythrocytes.

In addition, and as set forth in greater detail below, the amount of buffer required may be calculated, in advance, based on a titration curve previously established, adjusted for the amount of erythrocytes present.

For example, but not by way of limitation, where the enzyme to be used for erythrocyte conversion is coffee bean α-galactosidase (i.e., “B-zyme”; natural or recombinant), the conversion pH is preferably between 5.4 and 5.8 (inclusive) and, more preferably, 5.4-5.6.

As another nonlimiting example, where the enzyme to be used for erythrocyte conversion is chicken liver N-acetylgalactosaminidase (i.e., “A-zyme”; natural or recombinant), the conversion pH is preferably between pH 5.4-7.0, and, more preferably, 5.8-6.5.

As yet another nonlimiting example, where the enzyme to be used for erythrocyte conversion is endo-β-galactosidase from Flavobacterium keratolyticus (i.e., “ENDO-A”; natural or recombinant), the conversion pH is preferably between 5.4-7.0 and, more preferably 5.8-6.5.

The buffer to be used for titration is selected on the basis of its strength of buffering capacity (erythrocytes are naturally resistant to pH changes) as well as its compatibility with the physiology of erythrocytes.

A preferred buffer is phosphate citrate/sodium chloride and/or phosphate/sodium chloride. Another buffer which may be used is glycine/sodium citrate. Buffers containing acetate are preferably not employed.

The pH of the buffer may be selected as being at least one, and preferably more than two, pH units different from the conversion pH, the difference being in the same direction as the desired alteration in the pH of the native erythrocyte suspension. For example, where it is desired to bring the pH of a native erythrocyte suspension from 7.2 to a conversion pH of 5.4-5.6, the buffer preferably has a pH of 4.5 or less, and more preferably has a pH of less than 3.5. For example, but not by way of limitation, such buffer has a pH of greater than 2.0.

Once buffer has been added, with mixing, the resulting suspension may then be allowed to equilibrate, at room temperature, for at least 5-10 minutes, and preferably 10-15 minutes.

In a specific, nonlimiting example of the invention, phosphate citrate/sodium chloride buffer, pH 2.8 (which is 0.051M citric acid monohydrate, 0.019 M sodium phosphate dibasic (anhydrous), and 0.110 M sodium chloride), may be used to titrate a native erythrocyte suspension, having a hematocrit of 85-95 percent, to a pH of 5.4-5.6 by adding 0.59 gram of buffer per gram of the erythrocyte suspension, with mixing, for at least 10 minutes at room temperature.

Following equilibration, the hematocrit of the resulting erythrocyte suspension (referred to as the pre-conversion erythrocyte suspension) may be restored by centrifugation, expressing the desired amount of supernatant.

### 5.3. ENZYMATIC REMOVAL OF BLOOD TYPE-SPECIFIC ANTIGEN

Next, enzyme may be added to the pre-conversion erythrocyte suspension, at the conversion pH, so as to remove a sufficient amount of blood type-specific antigen such that a transfusion reaction is avoided (although the occurrence of any transfusion reaction whatsoever need not be absolutely prevented). For example, but not by way of limitation, the risk of a transfusion reaction occurring may be decreased by a factor of at least 10, and/or the extent of enzymatic removal of blood type-specific antigen may be such that the resulting enzyme-treated erythrocytes give a negative result in a standard hemagglutination assay testing for that blood type-specific antigen.

The concentration of enzyme used, and the duration of enzyme treatment, may vary based on the amount of erythrocytes to be converted, the concentration of erythrocytes, temperature, buffer system, and so forth, but means of compensating for changes in any of these parameters would be known to the skilled artisan.

For example, but not by way of limitation, in a first embodiment of the invention, where a standard blood unit (here, referring to a standard United States unit of packed red blood cells), concentrated to a hematocrit of 85-95 percent and constituting a pre-conversion erythrocyte suspension at a conversion pH of 5.4-5.8 and preferably 5.4-5.6, is to be converted to remove B antigen by coffee bean α-galactosidase, 32,000-45,000 enzyme units and preferably 45,000 enzyme units of coffee bean α-galactosidase (preferably recombinant coffee bean α-galactosidase expressed in Pichia pastoris) in a volume of 20-30 ml of phosphate citrate-sodium chloride buffer (which is 0.021 M citric acid monohydrate, 0.058 M sodium phosphate dibasic (anhydrous), and 0.077 M sodium chloride) pH 5.6±0.05, may be added to the erythrocyte suspension. The enzyme/erythrocyte mixture may then be incubated at a temperature of 4-37°C., preferably 26°C., for 1-24 hours, preferably 135 minutes, with gentle mixing.

In an alternate, second, specific nonlimiting embodiment of the invention, a standard blood unit concentrated to a hematocrit of 85-95 percent, constituting a pre-conversion erythrocyte suspension at a conversion pH of 5.4-5.8 and preferably 5.4-5.6, may be converted to remove B antigen by coffee bean α-galactosidase, by adding, to the erythrocyte suspension, 10,000-30,000 enzyme units, and preferably 20,000 enzyme units, of coffee bean α-galactosidase (preferably recombinant coffee bean α-galactosidase expressed in Pichia pastoris), in a volume of 8-15 ml of phosphate citrate/sodium chloride buffer (which is 0.021 M citric acid monohydrate, 0.058 M sodium phosphate dibasic (anhydrous), and 0.077 M sodium chloride), pH 5.6, and a solution of polyethylene glycol which contains about 10-40 percent and preferably 25-35 percent (weight/volume) of polyethylene glycol or an equivalent derivative thereof (having average molecular weight of about 1450-6000 daltons), so as to achieve, in the resulting enzyme/erythrocyte suspension, a polyethylene glycol concentration of about 1-6 percent, and preferably 2-4 percent. The enzyme/erythrocyte/polyethylene glycol mixture may then be incubated at a temperature of 4-37°C. and preferably 26°C. for 0.5-16 hours and preferably 1 hour, with gentle mixing. The addition of polyethylene glycol or its equivalent derivative may thus increase the efficiency of the enzyme, effecting the desired amount of antigen removal with less enzyme in a shorter period of time. In related embodiments, the enzyme may be included in the polyethylene glycol solution.

In another, third, specific nonlimiting embodiment of the invention, where a standard blood unit concentrated to a hematocrit of 85-95 percent, constituting a pre-conversion erythrocyte suspension at a conversion pH of 5.4-7.0, and preferably 5.8-6.5, is to be converted to remove A antigen by chicken liver N-acetylgalactosaminidase (preferably recombinant chicken liver N-acetylgalactosaminidase expressed in Pichia pastoris), 40,000-160,000 enzyme units, and preferably 60,000-120,000 enzyme units of chicken liver N-acetylgalactosaminidase in a volume of 10-40 ml. of phosphate/sodium chloride buffer pH 5.8-6.5 (prepared by adjusting the pH of a first solution, which is 0.050 M sodium phosphate dibasic (anhydrous) containing 0.093 M sodium chloride, with a second solution which is 0.050 M potassium phosphate monobasic containing 0.11 M sodium chloride), may be added to the erythrocyte suspension. The enzyme/erythrocyte mixture may then be incubated at a temperature of 4-37°C., preferably 26-37°C., for 2-24 hours, and preferably 2-5 hours, with gentle mixing. Alternatively, normal saline (0.9 percent sodium chloride, 150 mM) may be used in place of the foregoing buffer.

In a fourth specific nonlimiting embodiment, which is a variation of the preceding embodiment, and similar to the second embodiment set forth above, the erythrocyte/enzyme mixture may contain 1-6 percent and preferably 2-4 percent (weight/volume) polyethylene glycol or an equivalent derivative thereof, in which case the amount of N-acetylgalactosaminidase required may be decreased by 30-50 percent and the amount of time required for antigen removal may be decreased by 10-30 percent.

In a fifth specific nonlimiting embodiment, where a standard blood unit, concentrated to a hematocrit of 85-95 percent, constituting a pre-conversion erythrocyte suspension at a conversion pH of 5.4-7.0 and preferably 5.8-6.5, is to be converted to remove residual A antigen by β-endogalactosidase from Flavobacterium keratolytics, 10-120,000 enzyme units and preferably 10,000-40,000 enzyme units of βsaid β-endogalactosidase, in a volume of 0.5-40 ml. of phosphate/sodium chloride buffer pH 5.8-6.5 (prepared by adjusting the pH of a first solution, which is 0.050 M sodium phosphate dibasic (anhydrous) containing 0.093 M sodium chloride, with a second solution which is 0.050 M potassium phosphate monobasic containing 0.11 M sodium chloride), may be added to the erythrocyte suspension. The enzyme/erythrocyte mixture may then be incubated at a temperature of 4-37°, preferably 26-37°, for 2-24 hours, preferably 2-5 hours, with gentle mixing. Alternatively, normal saline (0.9 percent sodium chloride, 150 mM) may be used in place of the foregoing buffer.

In a sixth specific nonlimiting embodiment, which is a variation of the preceding embodiment, the erythrocyte/enzyme mixture may contain 1-6 percent and preferably 2-4 percent (weight/volume) of polyethylene glycol or an equivalent derivative thereof, in which case the amount of Flavobacterium keratolyticus β-endogalactosidase required may be decreased by 30-50 percent and to amount of time required for antigen removal may be decreased by 10-30 percent.

In a seventh specific, nonlimiting embodiment, a combination of chicken liver N-acetylgalactosaminidase and Flavobacterium keratolyticus β-endogalactosidase may be used to remove antigens from type A blood cells, using concentrations of enzyme, durations of treatment, etc. similar to those disclosed in relation to the preceding embodiments.

In an eighth specific, nonlimiting embodiment, a combination of coffee bean α-galactosidase and chicken liver N-acetylgalactosaminidase and/or Flavobacterium keratolyticus β-endogalactosidase may be used to remove antigens from type AB blood cells, using concentrations of enzyme, durations of treatment, etc. similar to those disclosed in relation to the preceding embodiments.

Sequential enzyme treatments or treatments utilizing simultaneous combinations of any of the foregoing enzymes or their functional equivalents may also be performed.

In those embodiments which utilize polyethylene glycol, its derivatives, about 0.5 grams of dextran sulfate may be substituted for 1 gram of polyethylene glycol.

Erythrocytes which have been treated with enzymes in such methods, such that blood type specific antigens have been removed to an extent which avoids transfusion reaction, are referred to as “converted erythrocytes”.

### 5.4. REMOVAL OF ENZYME AND TITRATION OF pH

Once antigen has been removed from the erythrocytes, the resulting converted erythrocytes may be treated so as to restore their pH to physiological levels (approximately pH 6.7-7.4), and so as to remove enzyme associated with the converted erythrocytes. Both goals may be achieved by a series of steps, some of which wash the converted erythrocytes, and others which titrate the pH of the converted erythrocytes to a physiological level.

The washes, for example, may be performed using any physiologic solution, wherein the converted erythrocytes are first suspended in the solution and then the supernatant is removed to restore the hematocrit to 75-95 percent and preferably 80-90 percent. The pH of the solution may be at a physiologic level (approximately 6.7-7.4). Suitable solutions include normal saline (0.9 percent sodium chloride, 150mM) as well as phosphate buffers. Washing may be performed in any centrifuge-based apparatus, including an automated cell washer, including, but not limited to, a Cobe 2991 Blood Cell Processor. At least one, preferably at least two washes are performed, and more preferably at least five washes are performed post conversion.

In addition, and preferably after one or two such washes, the pH of the converted erythrocytes may be titrated to reach a physiological level of 6.7-7.4.

The methods for titration are similar to those set forth in Section 5.2, supra, except that the pH of the buffer solutions used for titration are intended to change the pH in the opposite direction relative to the pH adjustment made prior to conversion.

The pH of the buffer may be selected as being at least one, and preferably at least two, pH units different from physiologic pH (6.7-7.4), the difference being in the same direction as the desired alteration in the pH of the converted erythrocytes. For example, where the pH of a suspension of converted erythrocytes is initially 5.5, then the titrating buffer preferably has a pH of at least 8, and more preferably, at least 9. For example, but not by way of limitation, the pH of such buffer is preferably less than 10.

In a specific, nonlimiting example, dipotassium phosphate buffer, l4OmM, pH 9-9.5 (which is 0.14M potassium phosphate dibasic (anhydrous), pH adjusted with 2N NaOH), may be used to titrate a converted erythrocyte suspension having a hematocrit of 75-95 percent, to a physiologic pH of 6.7-7.4 by adding 0.75-1.25 grams of buffer solution per gram of erythrocyte suspension, with mixing, for at least ten minutes at room temperature.

Following equilibration, the converted, pH-adjusted erythrocytes may be washed again, as set forth above, to produce transfusable erythrocytes ready for transfusion.

Alternatively, the transfusable erythrocytes may be further treated to remove additional antigen(s) or pathogen(s).

### 6. EXAMPLE

### CONVERSION OF TYPE B BLOOD CELLS TO TYPE H (TYPE O)

First, a unit of type B erythrocytes was spun and supernatant was removed by a plasma expresser to produce a native erythrocyte suspension having a hematocrit of 85-95%. The weight of the native erythrocyte suspension was determined.

While mixing, 0.59 grams of phosphate citrate-sodium chloride buffer, pH 2.8 (0.051M citric acid monohydrate; 0.019 sodium phosphate dibasic (anhydrous) and 0.110M sodium chloride) were added per gram of native erythrocyte suspension, and the resulting suspension was allowed to equilibrate for at least 10 minutes at room temperature, to produce an erythrocyte suspension having a pH of 5.4-5.6. Then the suspension was again centrifuged to express supernatant and produce a hematocrit of 85-90 percent.

Then, 45,000 units of recombinant coffee bean α-galactosidase were added in a volume of 20-30 ml of phosphate-citrate-sodium chloride buffer, pH 5.6±0.5 (0.021 M citric acid monohydrate, 0.058 M sodium phosphate dibasic (anhydrous), and 0.077 M sodium chloride). The reaction was performed under sterile conditions in a standard blood bag. The erythrocyte/enzyme suspension was incubated at 26°C. for 135 minutes, with mixing in an end-over-end rotator.

Then, the blood bag containing the erythrocyte/enzyme suspension was attached to the processing set of a Cobe 2991 Blood Cell Processor, and the converted erythrocytes were washed twice in normal saline (0.9 percent sodium chloride, 150 mM). To the erythrocyte suspension (hematocrit 75-85 percent) resulting after the second wash, 0.75-1.25 grams of dipotassium phosphate pH 8.8-9.2 (140 mM), were added per gram of erythrocyte suspension. The resulting suspension was equilibrated for at least ten minutes at room temperature. Then, the erythrocytes were washed four more times in normal saline to produce transfusable erythrocytes.

In vitro studies showed that the resulting transfusable erythrocytes lacked B antigen by anti-B hemagglutination assay (Walker, ed., 1990, Technical Manual. 10th ed., Arlington: American Association of Blood Banks, p. 539), as shown in TABLE I, exhibited normal osmotic fragility patterns and retained normal membrane and metabolic integrity.

TABLE I
Rate of Loss of B Antigenic Activity
1 mL Type B red cells treated with:

| | | | | | 85 units B-zyme | | |
|---|---|---|---|---|---|---|---|
| | 200 units B-zyme | | | | +PEG or Derivative | | |
| Incubation | 30′ | 60′ | 90′ | 135′ | 30′ | 60′ | 90′ |
| time [Min] | | | | | | | |
| Anti-B | 11 | 8 | 4 | 0 | 8 | 0 | 0 |
| Hemagglutination | | | | | | | |
| Score | | | | | | | |

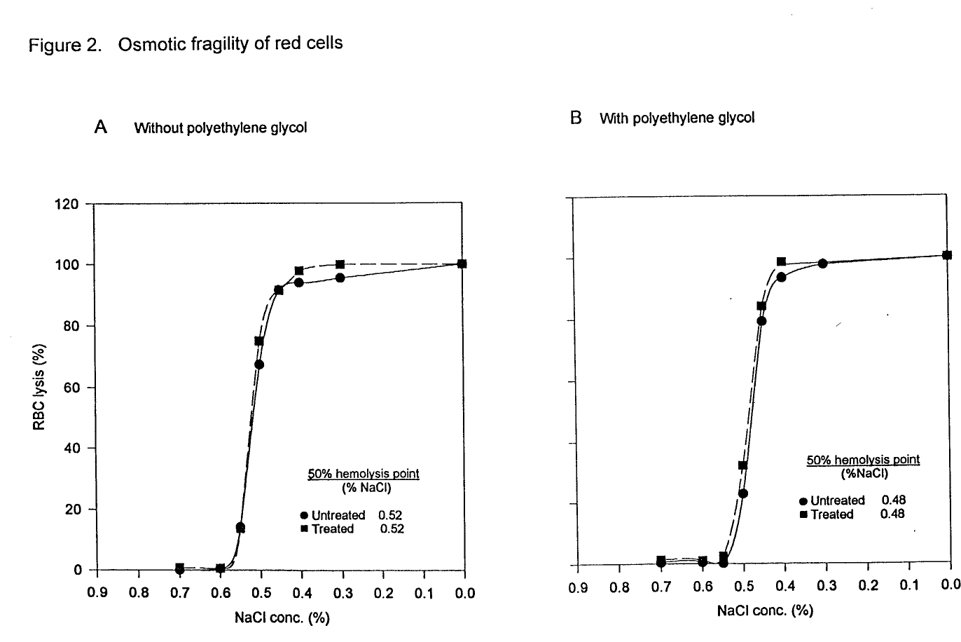

Fragility studies of enzymatically treated cells and appropriate controls are shown in FIG. 2A-B, and demonstrate that the treatment conditions do not produce any significant increase in susceptibility of these cells to osmotic shock (i.e. the 50 percent hemolysis values are equivalent in untreated and treated cells).

Cellular membrane and metabolic studies have indicated that ATP content in converted cells was essentially unchanged, 2-3-diphosphoglycerate (2,3-DPG) levels remained above 80 percent and methemoglobin was less than 1.5 percent after enzyme treatment. The foregoing allow for maintenance of erythrocyte cell shape and normal oxygen-binding and exchange. Furthermore, this protocol required approximately half the wash volume and twenty percent of the buffer volume as prior art methods, and could be accomplished in about 25 percent less time.

### 7. EXAMPLE

### CONVERSION USING POLYETHYLENE GLYCOL

It was found when the same procedure as set forth above was followed, except that polyethylene glycol was present during the enzyme conversion step, satisfactory B antigen removal was achieved with less enzyme and in a shorter period of time. Specifically, for enzyme conversion, 20,000 units of recombinant coffee bean α-galactosidase in a volume of 10-15 ml of phosphate citrate sodium chloride buffer, pH 5.6 (0.021 M citric acid monohydrate, 0.058 M sodium phosphate dibasic (anhydrous) and 0.077 M sodium chloride) were added to an erythrocyte suspension at a conversion pH of 5.4-5.6, with polyethylene glycol (average molecular weights 1450-6000 daltons) added as a 30% weight/volume solution in phosphate citrate-sodium chloride buffer, pH 5.6, to a final concentration of 2-4 percent (weight/volume). The resulting mixture was then incubated at 26°C. for 60 minutes, and then washed and pH adjusted as set forth in the preceding section. The resulting converted erythrocytes were negative in a standard hemagglutination assay in 60 minutes or less (see Table I, supra).

Various publications are cited herein, the contents of which are incorporated herein by reference in their entireties.

What is claimed is:

1. A method for enzymatically removing blood type-specific antigens from erythrocytes, comprising the following sequence of steps:
(a) titrating the pH of a native erythrocyte suspension to a conversion pH suitable for activity of a converting enzyme by adding a buffer solution having a pH at least one unit lower than the conversion pH;
(b) adding an amount of converting enzyme effective in removing a blood-type specific antigen from the erythrocytes;
(c) incubating the erythrocyte suspension containing the converting enzyme at a temperature and for a period of time sufficient to remove the blood type-specific antigen from the erythrocytes, thereby forming a converted erythrocyte suspension;
(d) titrating the pH of the converted erythrocyte suspension to a physiologic pH by adding a buffer having a pH of 8-10; and
(e) washing the erythrocytes to remove converting enzyme.

2. The method of claim 1 where the converting enzyme is coffee-bean α-galactosidase.

3. The method of claim 2 wherein the conversion pH is 5.4-5.8.

4. The method of claim 3 wherein the buffer solution used in step (a) has a pH of less than 3.5.

5. The method of claim 2 further comprising adding polyethylene glycol in step (b).

6. The method of claim 3 further comprising adding polyethylene glycol in step (b).

7. The method of claim 4 further comprising adding polyethylene glycol in step (b).

8. The method of claim 1 where the converting enzyme is a chicken liver N-acetylgalactosaminidase.

9. The method of claim 8 wherein the conversion pH is 5.4-7.0.

10. The method of claim 9 wherein the buffer solution used in step (a) has a pH of less than 3.5.

11. The method of claim 8, further comprising adding polyethylene glycol in step (b).

12. The method of claim 9, further comprising adding polyethylene glycol in step (b).

13. The method of claim 10, further comprising adding polyethylene glycol in step (b).

14. The method of claim 1 where the converting enzyme is an endo β-galactosidase of Flavobacterium keratolyticus.

15. The method of claim 14 wherein the conversion pH is 5.4-7/0.

16. The method of claim 15, wherein the buffer solution used in step (a) has a pH of less than ob 3.5.

17. The method of claim 14, further comprising adding polyethylene glycol in step (b).

18. The method of claim 15, further comprising adding polyethylene glycol in step (b).

19. The method of claim 16, further comprising adding polyethylene glycol in step (b).
